(19) United States
(12) Patent Application Publication
(10) Pub. No.: US 2009/0030839 A1
(43) Pub. Date: Jan. 29, 2009

(54) Method for Synchronizing Credit Point Data

(76) Inventors: Chen-Yi Kao, Hsinchu (TW); Hui-Jung Chang, Hsinchu (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/781,772

(22) Filed: Jul. 23, 2007

(51) Int. Cl. G06Q 40/00

(52) U.S. Cl. 705/41; 235/380

(57) ABSTRACT

A method for synchronizing credit point data can be applied in a smart card having a contact module and a contactless module. The contact module comprises a contact module storage unit for storing first credit points, and the contactless module comprises a contactless module storage unit for storing second credit points. When the contact module is utilized to update the credit points, at the beginning, the first credit points is set as the second credit points, the first credit points is updated, and then the second credit points is set as the updated first credit points.

### BACKGROUND OF THE INVENTION

1. Field of the Invention

The present invention relates to a method for synchronizing credit point data, and, more particularly, to a method for synchronizing credit point data by way of a contact module and a contactless module.

2. Description of the Related Art

It is becoming increasingly common to use smart cards as a means for transacting payments; the value stored within a smart card can be added to, deducted from or queried. Current smart cards are divided into two types: contact smart cards and contactless smart cards. Some smart cards support both a contact module and a contactless module, but they calculate credit point data individually. As a result, it is impossible to synchronize the credit points within the contact module and the contactless module.

Therefore, it is desirable to provide a method for synchronizing credit point data to mitigate and/or obviate the aforementioned problems.

### SUMMARY OF THE INVENTION

A main objective of the present invention is to provide a method for synchronizing credit point data which can maintain the consistency of the entire credit point data of the contact module and the contactless module.

Another objective of the present invention is to provide a smart card having a contact module and a contactless module, wherein the smart card having the contact module and the contactless module have two identical credit point data.

In order to achieve the above mentioned objectives, the method for synchronizing credit point data of the present invention can be applied in a smart card having a contact module and a contactless module; wherein the contact module comprises a contact module storage unit for storing first credit points, the contactless module comprising a contactless module storage unit for storing second credit points; the method enabling the smart card having the contact module and the contactless module to increase or reduce third credit points; the method comprising:

to increase the third credit points by way of the contact module:
setting the first credit points as the second credit points;
adding the third credit points to the first credit points to update the first credit points;
setting the second credit points as the first credit points;

to deduct the third credit points by way of the contact module:
setting the first credit points as the second credit points;
deducting the third credit points from the first credit points to update the first credit points;
setting the second credit points as the first credit points;

to add the third credit points by way of the contactless module:
adding the third credit points to the second credit points to update the second credit points; and

to deduct the third credit points by way of the contactless module:
deducting the third credit points from the second credit points to update the second credit points.

In order to achieve another objectives, the smart card having the contact module and the contactless module of the present invention comprises: a contact module having a contact interface; a contact module storage unit for storing first credit points; a processor; a memory, storing an application program; a contactless module electrically connected to the contact module and comprises a contactless interface; and a contactless module storage unit for storing second credit points. With the above-mentioned structure, the processor capable of executing the application program to achieve the following means with the contactless module:

to add the third credit points by way of the contact module:
setting the first credit points as the second credit points;
adding the third credit points to the first credit points to update the first credit points;
setting the second credit points as the first credit points;

to deduct the third credit points by way of the contact module:
setting the first credit points as the second credit points;
deducting the third credit points from the first credit points to update the first credit points;
setting the second credit points as the first credit points;

to add the third credit points by way of the contactless module:
adding the third credit points to the second credit points to update the second credit points; and

to deduct the third credit points by way of the contactless module:
deducting the third credit points from the second credit points to update the second credit points.

Other objects, advantages, and novel features of the invention will become more apparent from the following detailed description when taken in conjunction with the accompanying drawings.

### BRIEF DESCRIPTION OF THE DRAWINGS

FIG. 1 is a structural drawing of a smart card according to the present invention.

FIG. 2 is a flowchart of a method of the present invention.

FIG. 3 is a flowchart of a contactless module processing credit point data according to the present invention.

FIG. 4 is a flowchart of a contact module processing credit point data according to the present invention.

### DETAILED DESCRIPTION OF THE PREFERRED EMBODIMENT

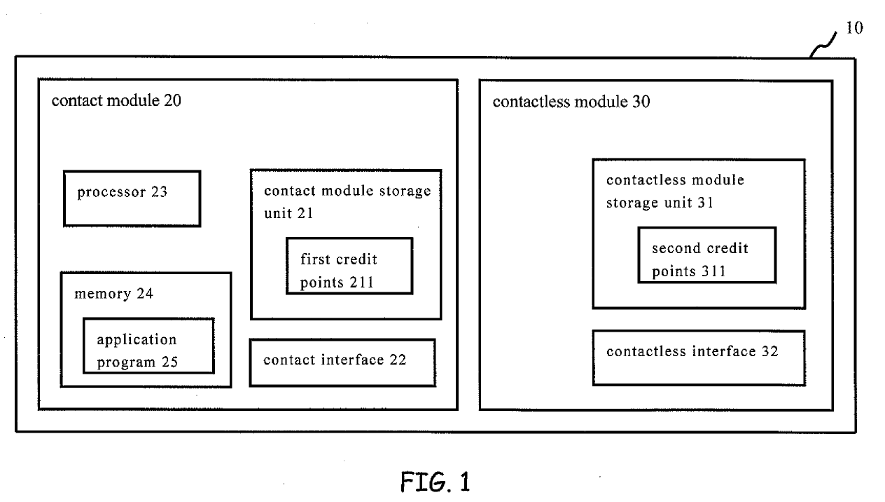

Please refer to FIG. 1. FIG. 1 is a structural drawing of a smart card according to the present invention. A smart card 10 comprises a contact module 20 and a contactless module 30.

The contact module 20 comprises a contact module storage unit 21, a contact interface 22, a processor 23 and a memory 24. The contact module storage unit 21 stores first credit points 211, and the memory 24 stores at least one application program 25 so the processor 23 can execute the application program 25 to change the first credit points 211.

The contactless module 30 comprises a contactless module storage unit 31 and a contactless interface 32, and the contactless module storage unit 31 stores second credit points 311.

The first credit points 211 and the second credit points 311 may represent valuable credit; for example, each point may represent one dollar. Or, the company issuing the smart card 10 may determine the value for the credit points; for example, the credit points may be exchanged for gifts.

Since it is a well-known technology to combine together the contact module 20 and the contactless module 30 into a single card, and as the underlying details of the contact module 20 (such as an IC card that satisfies the ISO7816 standard) and the contactless module 30 (such as a card that satisfies the ISO14443 standard) are also well-known, such aspects require no further description.

A main characteristic of the present invention is that after the processor 23 of the contact module 20 has executed the application program 25, the first credit points 211 and the second credit points 311 are identical.

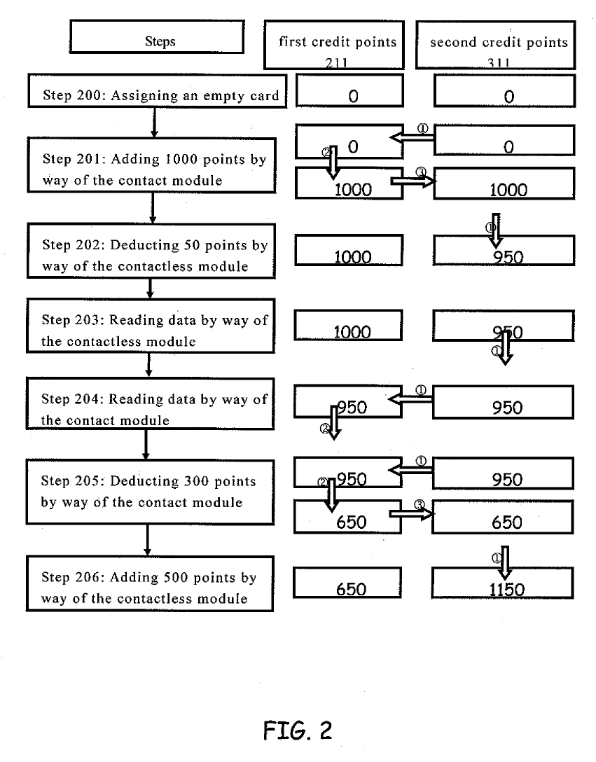

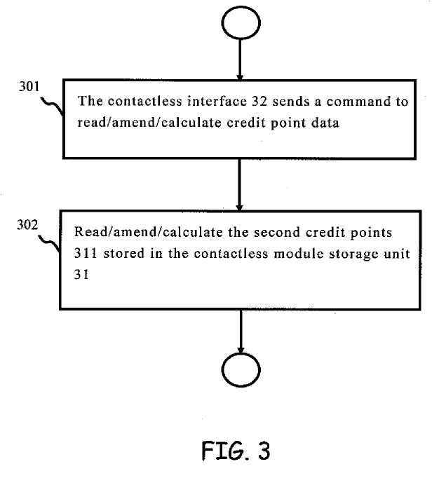

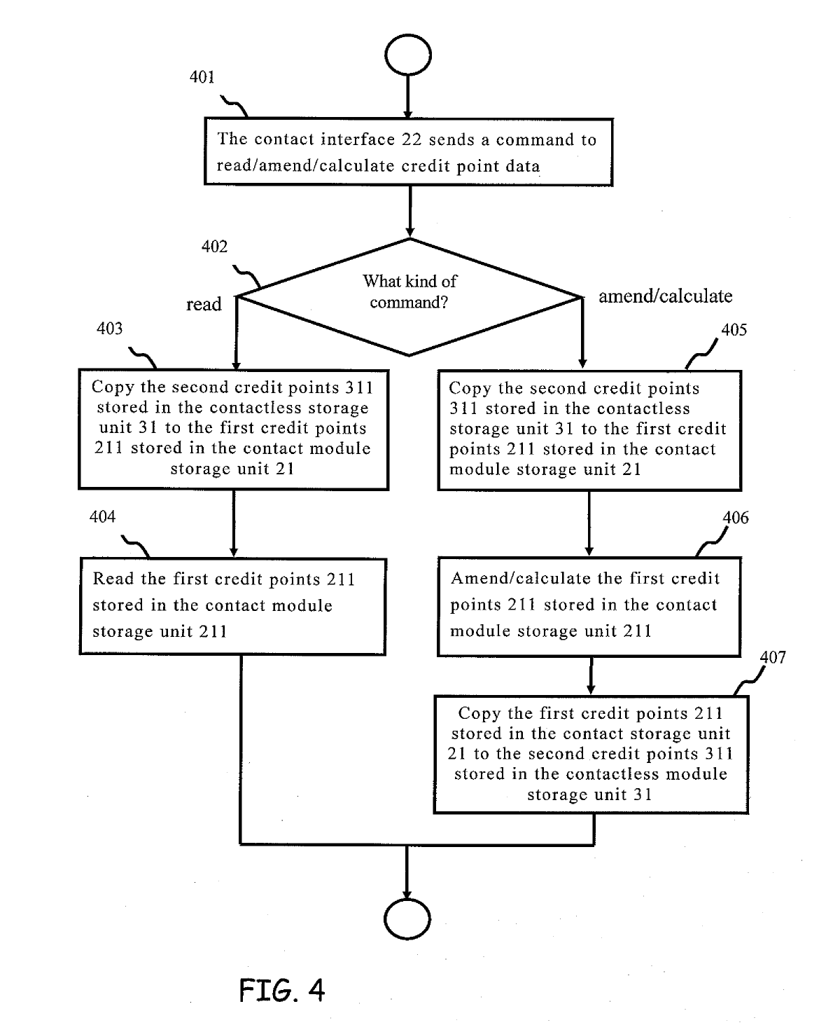

Please refer to FIG. 2 to FIG. 4. FIG. 2 is a flowchart of a method of the present invention. FIG. 3 is a flowchart of a contactless module processing credit points according to the present invention. FIG. 4 is a flowchart of a contact module processing credit points according to the present invention.

As shown in FIG. 2, a method of the present invention may add to the credit points, deduct from the credit points, or may query data concerning the credit points.

Step 200: Assigning an empty card (having zero credit points) as a new card.

The smart card 10 is an empty card, and the first credit points 211 stored in the contact module storage unit 21 and the second credit points 311 stored in the contactless module storage unit 31 are both zero.

Step 201: Adding 1000 points by way of the contact module.

Please refer to steps 401, 402, 405, 406, and 407 of FIG. 4. The contact interface 22 sends out a command to add 1000 points to the credit points (step 401). Because step 201 regards to amending or calculating procedure for credit point data, step 405 is proceeded (i.e., go to the right path of step 402). In step 405, the second credit points 311 stored in the contactless module storage unit 31 is copied to the first credit points 211 stored in the contact module storage unit 21. Since the second credit points 311 are at zero, after step 405, the first credit points 211 are at zero as well. In step 406, 1000 points are added to the first credit points 211 stored in the contact module storage unit 21; therefore the first credit points 211 have 1000 points. In step 407, the first credit points 211 stored in the contact module storage unit 21 are copied to the second credit points 311 stored in the contactless module storage unit 31. Since the first credit points have 1000 points, after step 407, the second credit points 311 also have 1000 points. Therefore, when the contact module 20 adds 1000 points, the first credit points 211 and the second credit points 311 are updated together.

Step 202: Deducting 50 points by way of the contactless module.

Please refer to steps 301, 302 of FIG. 3. The contactless interface 32 sends a command to deduct 50 points (step 301). In step 302, the second credit points 311 stored in the contactless module storage unit 31 is reduced by 50 points; since the second credit points 311 was 1000 points, the new second credit points 311 is now 950 points.

However, after step 202, while the second credit points 311 is 950 points, the first credit points 211 is still 1000 points. The first credit points 211 stored in the contact module storage unit 21 is not updated together with the second credit points 311 stored in the contactless module storage unit 31. The current contactless module 30 cannot simultaneously send the second credit points 311 to update the first credit points 211 until the next time the contact module 20 is activated and the second collected points 311 are copied to the first credit points 211. However, this will not affect the consistency of the entire credit point data.

Step 203: Reading data by way of the contactless module 30.

Please refer again to steps 301, 302 of FIG. 3. The contactless interface 32 sends a command to read the credit points (step 301), and in step 302, the second credit points 311 stored in the contactless storage unit 31 is read, which is 950 points. Then, step 203 terminates the procedure of reading the data by way of the contactless module 30.

In steps 202, 203, the contact module 20 is not activated; therefore, the first credit points 211 are not updated and the first credit points 211 remain at 1000 points.

Step 204: Reading data by way of the contact module 20.

Please refer again to steps 401, 402, 403, and 404 of FIG. 4. The contact interface 22 sends a command to read the credit points (step 401). Because step 204 regards to reading procedure for credit point data, step 403 is proceeded (i.e., go to the left path of step 402). The step 403 is performed to copy the second credit points 311 stored in the contactless storage unit 31 to the first credit points 211 stored in the contact module storage unit 21. Since the second credit points 311 are at 950 points, after step 403, the first credit points 211 are also at 950 points. In step 404, the first credit points 211 stored in the contact module storage unit 21 is read as 950 points, and step 204 ends the procedure of the contact module 20 reading the credit points.

Step 205: Deducting 300 points by way of the contact module 20.

Please refer to steps 401, 402, 405, 406, and 407 of FIG. 4. The contact interface 22 sends a command to deduct 300 points to the credit points (step 401). Because step 205 regards to amending or calculating for credit point data, step 405 is proceeded (i.e., go to the right path of step 402). In step 405, the second credit points 311 stored in the contactless module storage unit 31 are copied to the first credit points 211 stored in the contact module storage unit 21. Since the second credit points 311 are at 950 points, after step 405, the first credit points 211 are at 950 points. Next, in step 406, the first credit points 211 stored in the contact module storage unit 21 are calculated, which means 300 points are deducted from the first credit points 211; therefore, the first credit points 211 subtracts 300 points from 950 points and becomes 650 points. Finally, in step 407, the first credit points 211 stored in the contact module storage unit 21 is copied to the second credit points 311 stored in the contactless module storage unit 31; therefore, the second credit points 311 becomes 650 points. In step 205, the procedure of the contact module 20 deducting 300 points ends, as does the procedure of synchronizing the first credit points 211 and the second credit points 311.

Step 206: Adding 500 points by way of the contactless module.

Please refer to steps 301, 302 of FIG. 3. The contactless interface 32 sends a command to add 500 points to the credit points (step 301), and in step 302, 500 points are added to the second credit points 311 stored in the contactless module storage unit 31. Therefore, the second credit points 311 becomes 1150 points. In step 206, the procedure of adding 500 points by way of the contactless module 30 ends.

The method for synchronizing credit point data of the present invention by way of the contact module and the contactless module may not only be applied for valuable credit point data but may also be used for other types of data, such as issue dates, and serial numbers.

Although the present invention has been explained in relation to its preferred embodiment, it is to be understood that many other possible modifications and variations can be made without departing from the spirit and scope of the invention as hereinafter claimed.

1. A method for synchronizing credit point data, the method comprising:
providing a smart card having a contact module and a contactless module; wherein the contact module comprises a contact module storage unit for storing first credit points, with the contactless module comprising a contactless module storage unit for storing second credit points;
wherein the smart card achieves:
increasing credit points by way of the contact module comprising:
setting the first credit points as the second credit points;
adding the increasing credit points to the first credit points to update the first credit points; and
setting the second credit points as the first credit points;
reducing credit points by way of the contact module comprising:
setting the first credit points as the second credit points;
deducting the reducing credit points from the first credit points to update the first credit points; and
setting the second credit points as the first credit points;
increasing credit points by way of the contactless module comprising:
adding the increasing credit points to the second credit points to update the second credit points; and
decreasing credit points by way of the contactless module comprising:
deducting the decreasing credit points from the second credit points to update the second credit points.

2. The method as claimed in claim 1 further comprising:
reading status of the first credit points by way of the contact module comprising:
setting the first credit points as the second credit points; and
outputting the first credit points to be read.

3. The method as claimed in claim 1 further comprising:
reading status of the second credit points by way of the contactless module comprising:
outputting the second credit points to be read.

4. A smart card having a contact module and a contactless module, capable of adding or deducting credit points, the smart card comprising:
a contact module comprising:
a contact interface;
a contact module storage unit for storing first credit points;
a processor; and
a memory storing an application program;
a contactless module electrically connected to the contact module, with the contactless module comprising:
a contactless interface; and
a contactless module storage unit for storing second credit points;
with the processor executing the application program to achieve increasing credit points by way of the contact module comprising:
setting the first credit points as the second credit points;
adding the increasing credit points to the first credit points to update the first credit points; and
setting the second credit points as the first credit points;
decreasing credit points by way of the contact module comprising:
setting the first credit points as the second credit points;
deducting the decreasing credit points from the first credit points to update the first credit points; and
setting the second credit points as the first credit points;
increasing credit points by way of the contactless module comprising:
adding the increasing credit points to the second credit points to update the second credit points; and
decreasing credit points by way of the contactless module comprising:
deducting the decreasing credit points from the second credit points to update the second credit points.

5. The smart card having the contact module and the contactless module as claimed in claim 4 further comprising:
reading status of the first credit points by way of the contact module;
setting the first credit points as the second credit points; and
outputting the first credit points to be read.

6. The smart card having the contact module and the contactless module as claimed in claim 4 further comprising:
reading of the second credit points by way of the contactless module; and
outputting the second credit points to be read.
